(19) United States
(12) Patent Application Publication
(10) Pub. No.: US 2013/0162561 A1
(43) Pub. Date: Jun. 27, 2013

(54) TOUCH MODULE

(71) Applicant: SAMSUNG ELECTRO-MECHANICS CO., LTD., Suwon (KR)

(72) Inventors: Jae Hun Kim, Suwon (KR); Seul Gi Kim, Suwon (KR); Sang Su Hong, Suwon (KR); Jin Uk Lee, Suwon (KR)

(73) Assignee: SAMSUNG ELECTRO-MECHANICS CO., LTD., Suwon (KR)

(21) Appl. No.: 13/710,179

(22) Filed: Dec. 10, 2012

(30) Foreign Application Priority Data
Dec. 21, 2011 (KR) 10-2011-0139166

(51) Int. Cl. G06F 3/041

(52) U.S. Cl. CPC G06F 3/041
USPC 345/173

(57) ABSTRACT

Disclosed herein is a touch module including: a touch electrode formed on one surface or both surfaces of a transparent substrate; a connection part coupled to the touch electrode; and a coating layer coating the touch electrode and the connection part.

### CROSS REFERENCE TO RELATED APPLICATION

This application claims the benefit of Korean Patent Application No. 10-2011-0139166, filed on Dec. 21, 2011, entitled “Touch Module”, which is hereby incorporated by reference in its entirety into this application.

### BACKGROUND OF THE INVENTION

1. Technical Field

The present invention relates to a touch module.

2. Description of the Related Art

A touch module of a capacitive type is mainly manufactured by GFF, GG, or On Cell types. The GFF type is a type having two sheets of PET films in which ITO are deposited/patterned under a window glass, and GG type is a type in which a cover glass of an outer wall and a double-sided glass sensor of an inner portion are combined to each other.

An On Cell type is a type in which a glass sensor is attached to an OLED display for mobile.

ITO is currently used as a transparent electrode in all of the types. However, since the ITO has a limitation in decreasing sheet resistance, a sensor using a mesh type metal electrode will be on the rise hereafter. A recent research into a technology of a decrease in visibility at the time of manufacturing the mesh type metal electrode sensor as a module has been actively conducted. In particular, GG type or GF2 type using a mesh metal has been used

However, in the touch module which is currently researched or used, the metal electrode and the FPCB bonding part are weaker than the other parts, which causes a defect in reliability.

### SUMMARY OF THE INVENTION

The present invention has been made an effort to provide a touch module capable of improving reliability by coating a coupled portion between a touch electrode and a connection part.

According to a preferred embodiment of the present invention, there is provided a touch module including: a touch electrode formed on one surface or both surfaces of a transparent substrate; a connection part coupled to the touch electrode; and a coating layer coating the touch electrode and the connection part.

The coating layer may be formed so as to surround outer surfaces of the transparent substrate, the touch electrode, and the connection part.

The coating layer may be made of parylene.

The parylene dimer may be any one or more of parylene N, parylene C, parylene D, and parylene F.

The connection part may be formed of a flexible printed circuit board (FPCB).

### BRIEF DESCRIPTION OF THE DRAWINGS

The above and other objects, features and advantages of the present invention will be more clearly understood from the following detailed description taken in conjunction with the accompanying drawings, in which:

FIG. 1 is a cross-sectional view showing a touch module according to a preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

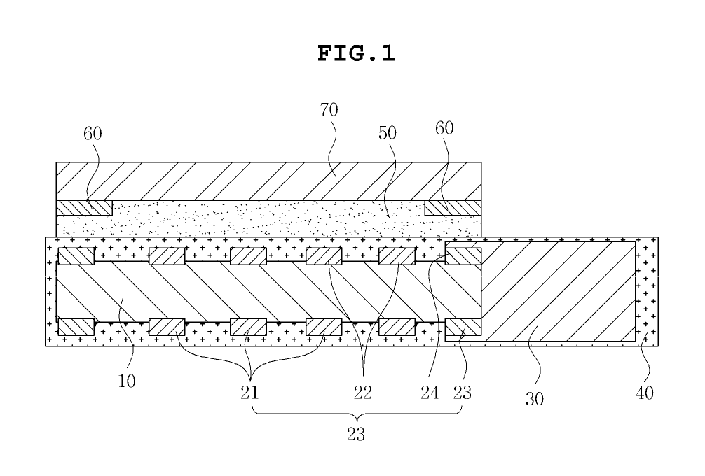

FIG. 1 is a cross-sectional view showing a touch module 100 according to a preferred embodiment of the present invention.

Referring to FIG. 1, the touch module 100 according to the embodiment of the present invention includes a touch electrode 20, a connection part 30, and a coating layer 40.

Referring to FIG. 1, the touch electrode 20 is formed on one surface or both surfaces of a transparent substrate 10.

In addition, the transparent substrate 10 may be made of any one of polyethylene terephthalate (PET), polycarbonate (PC), poly methyl methacrylate (PMMA), polyethylene naphthalate (PEN), polyethersulfone (PES), a cyclic olefin polymer (COC), a triacetylcellulose (TAC) film, a polyvinyl alcohol (PVA) film, a polyimide (PI) film, polystyrene (PS), biaxially oriented polystyrene (BOPS; containing K resin), glass, tempered glass, and the like.

Meanwhile, in order to activate both surfaces of the transparent substrate 10, a high frequency treatment or a primer treatment may be performed.

In addition, the touch electrode 20 includes a driving electrode 21 formed on one surface of the transparent substrate 10 and a sensing electrode 22 formed on the other surface of the transparent substrate 10. However, a structure of the touch electrode 20 of the touch module 100 according to the preferred embodiment of the present invention is not necessarily limited thereto. For example, the sensing electrode 22 and the driving electrode 21 may be formed together on one surface of the transparent substrate 10.

Here, the driving electrode 21 and the sensing electrode 22 may serve to generate signals at the time of touching the touch panel by a user to allow a controller to recognize touch coordinates.

In addition, the electrode pattern 20 may be formed in a mesh pattern by using copper (Cu), aluminum (Al), gold (Au), silver (Ag), titanium (Ti), palladium (Pd), chromium (Cr), or a combination thereof. Here, the touch electrode 20 may be formed by a plating process or a depositing process.

Meanwhile, in the case in which the electrode pattern 20 is made of copper (Cu), a surface of the touch electrode 20 may be black-oxide treated. Here, the black-oxide treatment indicates treatment in which Cu₂O or CuO is precipitated by oxidizing the surface of the touch electrode 20, wherein the Cu₂O is brown and is thus referred to as a brown oxide and the CuO is black and is thus referred to as a black oxide. As described above, the surface of the touch electrode 20 is black-oxide treated to prevent light from being reflected, thereby making it possible to improve visibility of the touch panel 100.

Further, the touch electrode 20 may be formed so that a line width thereof is 7 μm or less and a pitch is 900 μm or less, thereby making it possible to improve visibility. However, the line width and the pitch of the touch electrode 20 of the present invention are not limited thereto.

Meanwhile, the touch electrode 20 is positioned at edges of the driving electrode 21 and the sensing electrode 22 and includes electrode wirings 23 and 24 electrically connected to the driving electrode 21 and the sensing electrode 22, respectively.

Referring to FIG. 1, the connection part 30 is coupled to the touch electrode 20 to be electrically connected thereto.

Here, the connection part 30 is configured of a flexible printed circuit board (FPCB).

Here, the FPCB may be connected to the electrode wirings 23 and 24 of the touch electrode 20.

Referring to FIG. 1, the coating layer 40 is formed by coating the touch electrode 20 and the connection part 30.

In addition, the coating layer 40 is formed so as to surround outer surfaces of the transparent substrate 10, the touch electrode 20 and the connection part 30.

Further, the coating layer 40 is made of parylene which is a plastic material. Here, the parylene has excellent insulation, water resistance, corrosion resistance, chemical resistance, and the like, to protect a coupled portion between the touch electrode 20 and the connection part 30 and improve reliability.

In addition, the coating layer is formed by spraying a parylene dimer in a vacuum space. Here, chemical vapor deposition (CVD) apparatus may be used.

Here, the CVD apparatus is configured of three parts including a vaporizer, a pyrolysis, and a deposition chamber. The parylene dimer is inserted into the vaporizer as a powder type to be evaporated in a gas phase at 120 to 180° C., and then converted into a parylene monomer through pyrolysis heated at about 650 to 700° C. Lastly, the parylene dimer converted into the parylene monomer is coated within a deposition chamber at room temperature. That is, the coating layer is formed as a polymer by using a poly-para-Xylylene film within a vacuum chamber at room temperature.

In addition, the parylene dimer used herein is any one or more of parylene N (Di-Para-Xylylene), parylene C (Di-Chloro-Xylylene), parylene D (Tetra-Chloro-Xylylene) and parylene F (Octafluoro-[2,2]para-Cyclophane).

Here, all of the parylene N, C, D, and F types are distinguished from each other by a substituent in a six-membered ring carbon, in which both sides are connected to a CH₂ group. The parylene N type does not contain a substituent, the parylene C type contains a single chloro, the parylene D type contains two chloros, and the parylene F type contains a single fluoro. Here, the chloro may be a chlorine (Cl).

Meanwhile, the touch module 100 according to the embodiment of the present invention, an insulating layer 50 may be coated on one surface of the coating layer 40 coated with parylene, covering films 60 may be formed at edges of the insulating layer 50, and a window 70 may be stacked on outer surfaces of the insulating layer 50 and the covering film 60.

Here, the insulating layer 50 may be positioned on an upper surface or a lower surface of the transparent substrate 10 and the touch electrode 20.

In addition, the covering film 60 may be positioned in an upper direction of the electrode wirings 23 and 24.

Further, the window 70 may be made of a glass or a film.

According to the present invention, the coupled portion between the touch electrode and the connection part is coated with parylene to significantly improve insulation, water resistance, corrosion resistance, chemical resistance properties, and the like, such that the reliability thereof may be improved.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A touch module comprising:
a touch electrode formed on one surface or both surfaces of a transparent substrate;
a connection part coupled to the touch electrode; and
a coating layer coating the touch electrode and the connection part.

2. The touch module as set forth in claim 1, wherein the coating layer is formed so as to surround outer surfaces of the transparent substrate, the touch electrode, and the connection part.

3. The touch module as set forth in claim 1, wherein the coating layer is made of parylene.

4. The touch module as set forth in claim 3, wherein the parylene dimer is any one or more of parylene N, parylene C, parylene D, and parylene F.

5. The touch module as set forth in claim 1, wherein the connection part is formed of a flexible printed circuit board (FPCB).
